(19) United States
(12) Patent Application Publication
(10) Pub. No.: US 2002/0129714 A1
(43) Pub. Date: Sep. 19, 2002

(54) Cooking apparatus

(75) Inventors: Sung-ho Lee, Hwasung city (KR); Han-jun Sung, Suwon city (KR); Chul Kim, Anyang city (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-city (KR)

(21) Appl. No.: 10/095,043

(22) Filed: Mar. 12, 2002

(30) Foreign Application Priority Data
Mar. 13, 2001 (KR) 2001-12941
Jan. 31, 2002 (KR) 2002-5711

(51) Int. Cl. A47J 37/12

(52) U.S. Cl. 99/403; 99/417

(57) ABSTRACT

A cooking apparatus having a cooker body with a top opening and a lid including a collector part depressed downward to collect condensed water therein, and a through hole formed at the bottom of the accommodating part to communicate the inside of the cooker body and the outside thereof, the lid used to close the top opening. With this configuration, the cooking apparatus properly discharges the steam generated with the cooker body during cooking and collects the condensed water back into the cooker body.

### CROSS-REFERENCE TO RELATED APPLICATIONS

This application claims the benefit of Korean Patent Application No. 2001-12941 filed on Mar. 13, 2001 and Korean Patent Application No. 2002-5711 filed on Jan. 31, 2002, in the Korean Industrial Property Office, the disclosure of which is incorporated herein by reference.

### BACKGROUND OF THE INVENTION

1. Field of the Invention

The present invention relates to cooking apparatuses, and more particularly, to a cooker with an improved structure of the lid thereof.

2. Description of the Related Art

There are cooking apparatuses such as conventional rice cookers and cook pots which are used in cooking rice or making stew. These conventional cooking apparatuses are generally comprised of a cylindrical cooker body accommodating food to be cooked therein, and a lid opening and closing the top part of the cooker body. A user first puts ingredients for any desired food to be cooked in the cooker body, covers the cooker body with the lid, puts the cooker on a gas range or in a microwave oven and heats the cooker, to make the food.

When the cooker is heated, increased pressure is generated within the cooker body. The over pressure causes the lid to be shaken. When the lid is shaken, the food sometimes boils over. In order to enhance the cooked rice in taste and quality, the inner pressure of the cooker body should be suitably maintained. However, ordinary cookers have the problem in which their lids move up and down while cooking rice, thereby allowing the pressure to escape out of the cooker body, and as a consequence, the cooked rice is poor in taste and quality. In addition, heating apparatuses such as a microwave oven, a gas range, etc., become dirty due to the boiled-over food from these conventional food cookers.

In an effort to solve these problems, there has been proposed a cooker equipped with a lid having a through hole with a predetermined size through which vapor and steam within the cooker body are appropriately discharged, thereby preventing the lid from moving up and down. However, this cooker has shown that condensed water of the steam mixed with the food materials has been discharged along with the vapor and steam through the through hole, thereby making the lid dirty.

Taking the above into consideration, there is a need for a cooker capable of appropriately discharging the vapor and steam generated within the cooker body and of collecting the condensed water, thereby preventing an over pressure from being generated within the cooker body and the lid from becoming dirty while food is being cooked.

### SUMMARY OF THE INVENTION

Accordingly, it is an object of the present invention to provide a cooking apparatus capable of appropriately discharging vapor and steam generated within a cooker body and collecting condensed water.

Additional objects and advantages of the invention will be set forth in part in the description which follows and, in part, will be obvious from the description, or may be learned by practice of the invention.

The foregoing and other objects of the present invention are accomplished by providing a cooking apparatus comprising: a cooker body having a top opening; and a lid to close the top opening including a collector part depressed downward to collect condensed water therein, and a through hole formed at the bottom of the collector part to communicate the inside of the cooker body with the outside thereof.

In an embodiment of the present invention, the lid includes an elevated part having a conical shape elevated upward in the central portion thereof, and an outer circumferential wall inclinedly extended upward from a lower outer circumference of the elevated part; and the collector part formed with a space between the elevated part and the outer circumferential wall.

The through hole includes an upper through hole formed in an upper end part of the elevated part, and at least one lower through hole formed in the bottom of the collector part.

An embodiment of the present invention provides that the cooking apparatus also comprises a cap to prevent steam from being discharged, the cap provided on the upper end part of the elevated part so as to enclose the upper through hole and having at least one side guide hole therein.

An embodiment of the present invention also provides that the central portion of the elevated part is depressed downward and the through holes are formed in the depressed central portion of the elevated part and in the bottom of the collector part.

An embodiment of the present invention also provides that the collector part is formed at the upper part of the lid so as to be funnel-shaped, and the through hole is formed on the bottom of the collector part.

An embodiment of the present invention also provides that a plurality of auxiliary through holes are provided around the through hole.

An embodiment of the present invention also provides that the cooking apparatus further comprises a closing member intervened between the edge of the opening of the cooker body and the lower edge of the lid.

An embodiment of the present invention also provides that a downward projection part is formed at the lower edge of the lid and fitted into the opening of the cooker body, and the closing member is provided between the projection part and the outside edge of the opening of the cooker body.

### BRIEF DESCRIPTION OF THE DRAWINGS

These and other objects and advantages of the present invention will become apparent and more readily appreciated from the following description of the embodiments, taken in conjunction with the accompanying drawings of which:

FIG. 1 is a perspective view of a cooking apparatus according to an embodiment of the present invention;

FIG. 2 is a side sectional view of the cooking apparatus of FIG. 1;

FIG. 3 is a side sectional view of a cooking apparatus according to another embodiment of the present invention;

FIG. 4 is a side sectional view of a cooking apparatus according to yet another embodiment of the present invention;

FIG. 5 is a side sectional view of a cooking apparatus according to yet another embodiment of the present invention;

FIG. 6 is a perspective view illustrating a bottom of a lid of FIG. 5; and

FIG. 7 is a front view of the cooking apparatus of FIG. 5.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

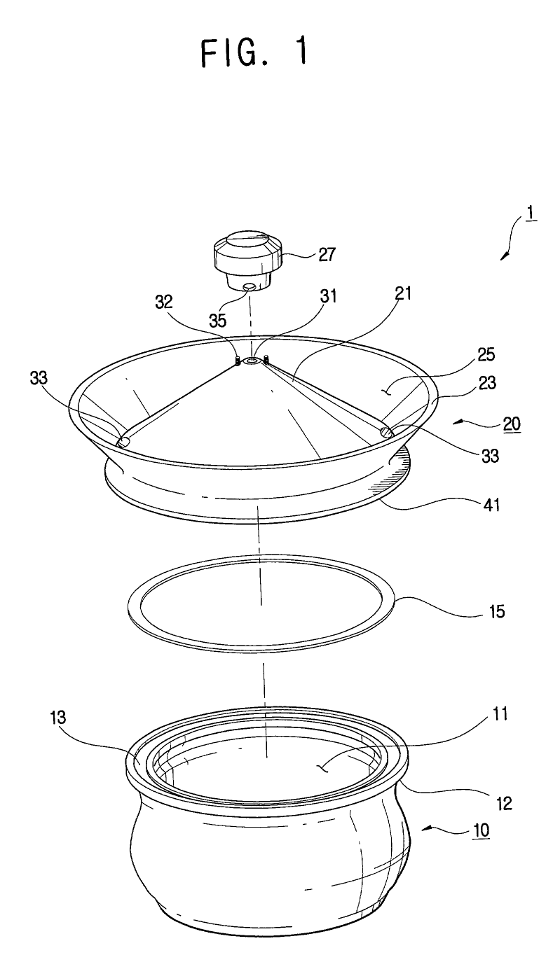

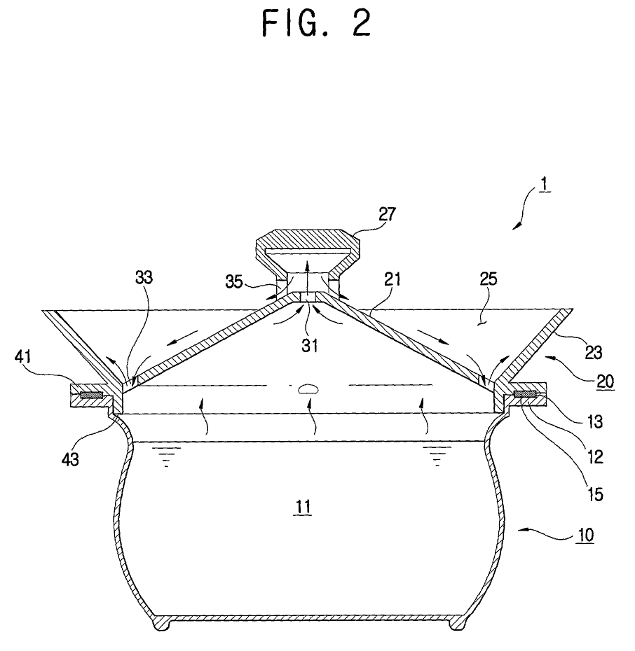

FIG. 1 is a perspective view of a cooking apparatus according to an embodiment of the present invention, and FIG. 2 is a side sectional view of the cooking apparatus of FIG. 1. As shown in these figures, a cooker 1 comprises a cylindrical cooker body 10 with a top opening forming a space 11 to receive food to be cooked therein, and a lid 20 opening and closing the top opening of the cooker body 10.

On the upper end of the cooker body 10 is formed a lower flange 12 along the circumference thereof. On the top face of the lower flange 12 is formed an engagement part 13. The engagement part 13 of the lower flange 12 is engaged with a ring-shape closing member 15 made of heat-resistant rubber. The cooker body 10 may be molded with metal or glass, which are excellent materials for withstanding heat.

An elevated part 21 taking a conical shape is upwardly elevated toward the center of the lid 20. Along the circumference of the lid 20 is formed an outer wall 23 extended upwardly and outwardly from the lower circumferential edge of the elevated part 21. A recessed space formed between the elevated part 21 and the outer wall 23 functions as a collector part 25 to collect condensed water therein. On the upper end of the elevated part 21 and the lower part of the collector part 25 are formed an upper through hole 31 and a lower through hole 33, respectively. The upper through hole 31 and the lower through hole 33 operate to communicate the collector part 25 with the food accommodating space 11 of the cooker body 10 when the lid 20 covers and closes the opening of the cooker body 10. An embodiment of the present invention further provides that a plurality of lower through holes 33 are formed at predetermined intervals along the circumference of the collector part 25.

The top of the elevated part 21 of the lid 20 is coupled to a cap 27 to prevent steam within the cooker body 11 from being discharged and to enclose the upper through hole 31. The top of the cap 27 is closed. On the circumferential wall of the cap 27 is formed at least one guide hole 35 directed toward the collector part 25. The cap 27 is coupled to the lid 20 by screws as illustrated in FIG. 1. Alternatively, the cap 27 may be coupled to the lid 20 using a variety of methods, for example, a complementary projection and groove.

On the lower circumference of the lid 20 are formed an upper flange 41 in close contact with the lower flange 12 of the cooker body 10 and a projection 43 (FIG. 2) fitted into the opening of the cooker body 10. The bottom face of the upper flange 41 and the top face of the lower flange 12 may be finished by polishing so as to allow them to be in close contact with each other. The projection 43 protrudes downward by a predetermined depth from the lower circumference of the lid 20. By this, the projection 43 is fitted into the inner side of the opening of the cooker body 10 under the state that the lid 20 closes the cooker body 10, and thus, the movement of the lid 20 during cooking can be prevented. To more effectively prevent the movement of the lid 20 due to the pressure formed within the cooker body 10, the lid 20 is manufactured to have an appropriate weight.

With this configuration, if the cooker body 10 containing food therein is heated by a heating apparatus such as a gas range or a microwave oven, etc., to cook the food, the steam and condensed water formed within the cooker body 10 flow into the collector part 25 through the lower through hole 33 and the upper through hole 31 of the lid 20 to maintain the pressure within the cooker body 10 appropriately.

The steam and water passing through the upper and lower through holes 31 and 33 are discharged at a quick velocity due to the high pressure formed within the cooker body 10. However, the steam and water discharged through the upper through hole 31 are prevented from dissipating into the air because of the cap 27, and the steam and water discharged through the lower through hole 33 are dispersed within the collector part 25, thereby lowering the force of discharging them. The condensed water discharged through the upper and lower through holes 31 and 33 moves downward along the inclined wall side of the collector part 25 formed by the central elevated part 21 and the outer wall 23, and then flows back into the cooker body 10 through the lower through hole 33. Thus, the generation of the over-pressure within the cooker body 10 and the dissipation of the condensed water into the air are both prevented.

When the upper and/or lower through holes 31 and 33 are clogged with any ingredients of the food such as a grain of rice, etc., the lid 20 may be maintained in its clogged state until the pressure in the cooker body 10 reaches the weight of the lid 20. When the pressure within the cooker body 10 increases to exceed the weight of the lid 20, the lid 20 is lifted up and down from the cooker body 10 due to the over pressure within the cooker body 10. The lid 20 is lifted so as not to be separated from the cooker body 10 owing to the projection 43 formed at the lower part of the lid 20. By this, the over-pressure within the cooker body 10 is decreased. If the over pressure within the cooker body 10 is decreased, the lid closes the upper opening of the cooker body 10 by its own weight. Thus, the generation of the over pressure within the cooker body 10 is prevented, and boiling-over of the food can be effectively avoided.

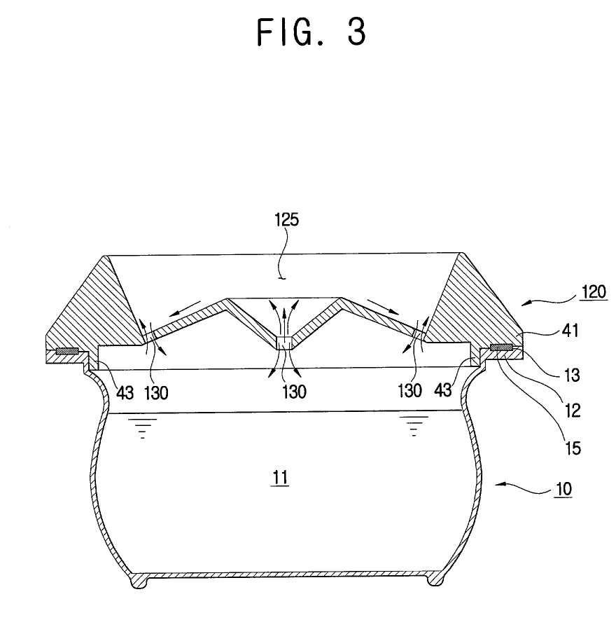

Referring to FIG. 3, which is a side sectional view of a cooking apparatus according to another embodiment of the present invention, a cooker according to the present embodiment has an elevated part 121 whose central portion is depressed downward. Accordingly, the bottom face of the collector part 125 is constructed to have a plurality of valleys. On the bottom part of each valley are formed a plurality of through holes 131 and 133 communicating the inside of the cooker body 10 with the collector part 125.

In the cooker according to this embodiment of the present invention, while the steam of high temperature and high pressure formed within the cooker body 10 flows into the collector part 125 from the inside of the cooker body 10 through each of the through holes 131 and 133, the pressure within the cooker body 10 can be maintained as appropriate. The steam and condensed water discharged from the inside of the cooker body 10 are dispersed within the collector part 125, lowering the force of discharging them. The discharged water moves downward to the bottom of each valley along the inclined surface of the collector part 125, and then flows back into the cooker body 10 through each of the through holes 131 and 133. Formation of over-pressure within the cooker body 10 and outer discharge of the condensed water are both prevented.

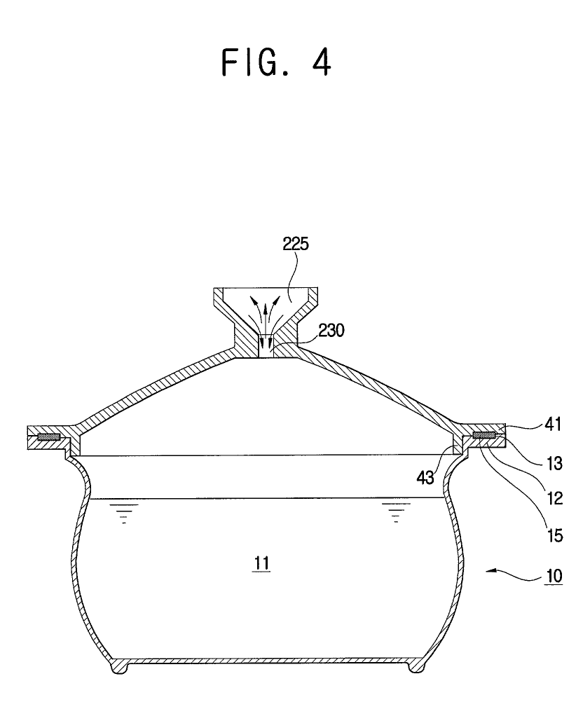

As illustrated in FIG. 4, which is a side sectional view of a cooking apparatus according to another embodiment of the present invention, the cooker according to this embodiment has a funnel-shaped collector part 225 formed in the central part of a convex lid 220. On the inner bottom of the accommodating part 225 is formed a single through hole 230 communicating the inside of the cooker body 10 with the collector part 225.

In the cooker according to the present embodiment, while the steam of high temperature and high pressure formed within the cooker body 10 discharges into the collector part 225 from the inside of the cooker body 10 through the through hole 230, the pressure within the cooker body 10 can be maintained as appropriate. The steam and condensed water discharged from the inside of the cooker body 10 through the through hole 230 are dispersed within the collector part 225, lowering the potential of dissipating them. The discharged water moves along the inclined wall side of the collector part 225, and then flows back into the cooker body 10 through the through hole 230. Thus, the generation of over-pressure of the cooker body 10 and the discharge of the condensed water are both prevented.

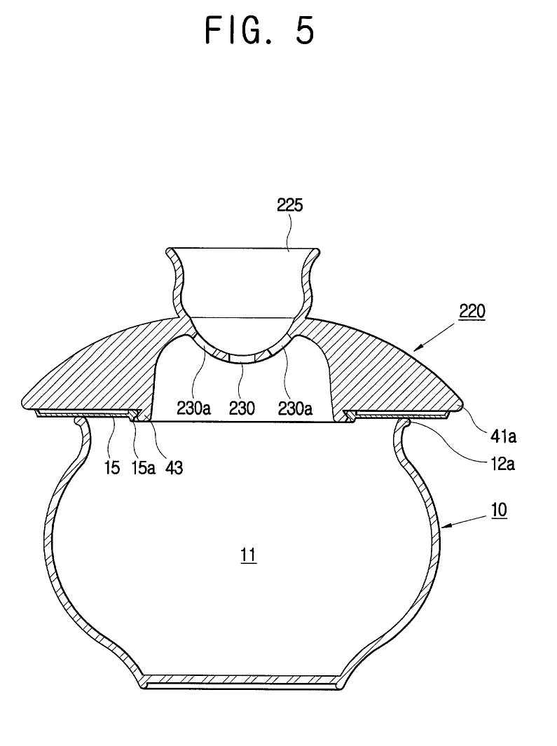

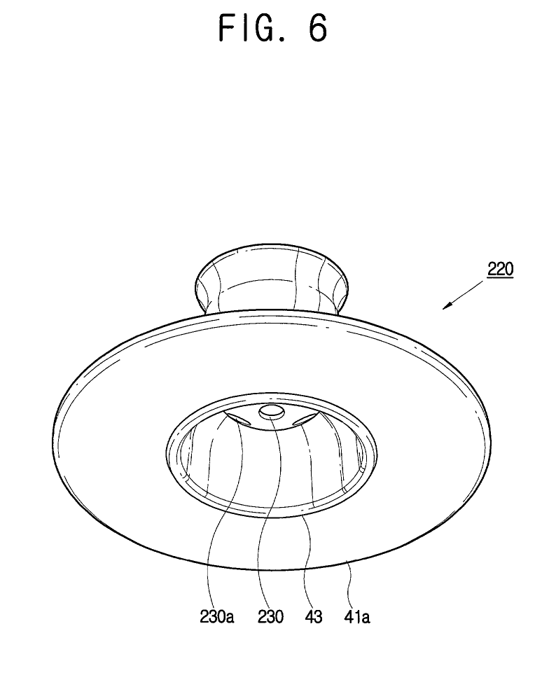

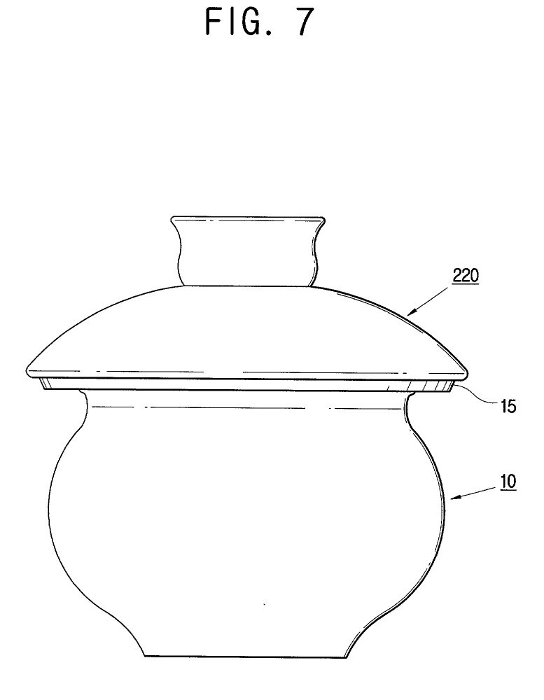

FIGS. 5 through 7 illustrate a cooking apparatus according to another embodiment of the present invention. The cooker according to this embodiment is similar to the cooker according to the previous embodiment of FIG. 4, but different therefrom as follows. First, around the central through hole 230 is provided a plurality of auxiliary through holes 230a. Second, an upper flange 41 a is in indirect contact with a lower flange 12a, and the upper and lower flanges 41a and 12a are different from those of the previous embodiment in shape. Third, the closing member 15 is provided with a protruding part 15a placed between the projection 43 of the upper flange 41 a and the lower flange 12a, and is mounted on the bottom of the upper flange 41a.

As described above, the collector part 225, communicating with the inside of the cooker body 10 and formed in the lid, allows the steam generated within the inside of the cooker body 10 to be discharged appropriately and the condensed water to be collected back into the cooker body 10, thereby preventing generation of over-pressure within the cooker body and maintaining the pressure within the cooker body as appropriate. Further, boiling over of the food and dissipation of the steam and condensed water can be prevented.

According to the present invention, when cooking rice by a cooking apparatus according to the present invention, the lifting up and down of the lid is prevented and the pressure within the cooker body is properly maintained, thereby enhancing the taste and quality of the cooked rice. This is achieved by providing a cooking apparatus capable of properly discharging the steam generated with the cooker body during cooking and collecting the condensed water back into the cooker body.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A cooking apparatus comprising:
a cooker body having a top opening; and
a lid to close said top opening, said lid including a collector part depressed downward to collect condensed water therein, and a through hole formed at the bottom of said collector part to communicate the inside of the cooker body with said collector part.

2. The cooking apparatus according to claim 1, wherein said lid includes an elevated part having a conical shape elevated upward and an upper through hole in the central portion thereof, and an outer circumferential wall inclinedly extended upward from a lower outer circumference of said elevated part; and
said collector part being between the elevated part and said outer circumferential wall.

3. The cooking apparatus according to claim 2, further comprising:
an upper through hole formed in an upper end part of the elevated part; and
at least one additional through hole formed in the bottom of said collector part.

4. The cooking apparatus according to claim 3, further comprising a cap to prevent steam from being discharged, said cap provided on the upper end part of said elevated part so as to enclose the upper through hole and having at least one side guide hole therein.

5. The cooking apparatus according to claim 2, wherein the central portion of said elevated part is depressed downward.

6. The cooking apparatus according to claim 5, wherein said upper through hole is formed in said depressed central portion of said elevated part.

7. The cooking apparatus according to claim 1, wherein said collector part is provided at the upper part of said lid and has a funnel shape.

8. The cooking apparatus according to claim 7, further comprising a plurality of auxiliary through holes provided around said through hole.

9. The cooking apparatus according to claim 1, further comprising a closing member intervened between the edge of the opening of said cooker body and the lower edge of said lid.

10. The cooking apparatus according to claim 9, wherein at the lower edge of said lid is formed a downward projection part fitted into the opening of said cooker body, said closing member provided with a protruding part between said projection part and the edge of the opening of said cooker body.

11. The cooking apparatus according to claim 9 further comprising:
a lower flange formed along the circumference of the upper end of said cooker body, said lower flange having an engagement part to receive said closing member therein.

12. The cooking apparatus according to claim 9, wherein said closing member is formed of a heat-resistant rubber.

13. The cooking apparatus according to claim 1, wherein said cooker body is molded of metal.

14. The cooking apparatus according to claim 1, wherein said cooker body is molded of glass.

15. The cooking apparatus according to claim 2, wherein said outer circumferential wall extends outwardly from a lower circumferential edge of said elevated part.

16. The cooking apparatus according to claim 1, further comprising a plurality of through holes formed at predetermined intervals along the circumference of said collector part.

17. The cooking apparatus according to claim 11, wherein said lid further comprises an upper flange, said upper flange in close contact with said lower flange when said top opening is closed such that said closing member is between said upper flange and said lower flange.

18. A cooking apparatus comprising:
a cooker body having a top opening;
a lid to open/close said top opening, said lid discharging steam generated within said cooker body and collecting and reintroducing condensed water generated within the cooker body back into the cooker body.

19. The cooking apparatus according to claim 18, wherein the lid comprises:
a collector part with a first through hole formed in a bottom thereof;
wherein the steam escapes through the first through hole and the condensed water escapes through the first through hole from within said cooker body and collected by the collector part and travels back to within the cooker body from the collector part via the first through hole.

20. The cooking apparatus according to claim 19, wherein the lid further comprises a second through hole at a top portion of the collector part, wherein the steam escapes through the second through hole and the condensed water escapes through the second through hole into the collector part.

21. The cooking apparatus according to claim 19, wherein the lid further comprises a an elevated portion with a central portion depressed downward so as to form a plurality of valleys in a cross-section of the lid, and a second through hole at a bottom portion of central portion, wherein the steam escapes through the second through hole and the condensed water escapes through second first through hole from within said cooker body and collected by the collector part and travels back to within the cooker body from the collector part via the second through hole.
